(19) United States
(12) Patent Application Publication
(10) Pub. No.: US 2026/0209534 A1
(43) Pub. Date: Jul. 23, 2026

(54) INK

(71) Applicant: KYOCERA DOCUMENT SOLUTIONS INC., OSAKA-SHI, OSAKA (JP)

(72) Inventors: HIROKA ITANI, OSAKA-SHI, OSAKA (JP); KOTATSU KAWAGUCHI, OSAKA-SHI, OSAKA (JP); KATSUKI OSANISHI, OSAKA-SHI, OSAKA (JP); MOTOKI SUZUKI, OSAKA-SHI, OSAKA (JP); SHUN KANDA, OSAKA-SHI, OSAKA (JP); KENTARO OKINAKA, OSAKA-SHI, OSAKA (JP)

(21) Appl. No.: 19/449,362

(22) Filed: Jan. 14, 2026

(30) Foreign Application Priority Data
Jan. 17, 2025 (JP) 2025-007087

(51) Int. Cl. C09D 11/30; C09D 11/102

(52) U.S. Cl. CPC C09D 11/30; C09D 11/102

(57) ABSTRACT

An ink has viscosity of 7.5 mPa·s or less at 25° C. The ink includes: a pigment a, a polyethylene glycol b, a water-soluble solid additive c that is solid at 25° C., a penetrating agent d, a surfactant e, and water. The polyethylene glycol b includes a first polyethylene glycol b1 having a number average molecular weight of 150 or more and less than 450 and a second polyethylene glycol b2 having a number average molecular weight of 450 or more and less than 1050. In the ink, a content of the first polyethylene glycol b1 is 5 mass % or more and 10 mass % or less. In the ink, a content of the second polyethylene glycol b2 is 1 mass % or more and 5 mass % or less. A content of the water-soluble solid additive c being 3 mass % or more and 10 mass % or less.

### CROSS-REFERENCE TO RELATED PATENT APPLICATION

This application claims the benefit of Japanese Priority Patent Application JP 2025-007087 filed on Jan. 17, 2025, the entire contents of which are incorporated herein by reference.

### FIELD OF THE DISCLOSURE

The present disclosure relates to an ink for forming an image by an inkjet method.

### BACKGROUND OF THE DISCLOSURE

An inkjet recording apparatus forms an image on a recording medium such as paper by repeatedly ejecting small droplets of ink from a nozzle onto the recording medium. In the recording medium such as paper formed of a fiber, a phenomenon (curling) in which the formation of an image by ink causes partial expansion and contraction of fibers, resulting in a warped shape, is likely to occur. In this regard, there has been known a technology that blends polyethylene glycol in ink in order to prevent curling from occurring.

### SUMMARY OF THE DISCLOSURE

An ink according to an embodiment of the present disclosure has viscosity of 7.5 mPa·s or less at 25° C.

The ink includes: a pigment a; a polyethylene glycol b; a water-soluble solid additive c that is solid at 25° C.; a penetrating agent d; a surfactant e; and water.

The polyethylene glycol b includes a first polyethylene glycol b1 having a number average molecular weight of 150 or more and less than 450 and a second polyethylene glycol b2 having a number average molecular weight of 450 or more and less than 1050.

In the ink, a content of the first polyethylene glycol b1 is 5 mass % or more and 10 mass % or less.

In the ink, a content of the second polyethylene glycol b2 is 1 mass % or more and 5 mass % or less.

A content of the water-soluble solid additive c is 3 mass % or more and 10 mass % or less.

### DETAILED DESCRIPTION OF THE EXEMPLARY EMBODIMENTS

In some inkjet recording apparatuses, inks used for forming images are desired to have low viscosity due to requirements from the specifications of the recording head. In this regard, in inks in which polyethylene glycol is blended, the viscosity tends to increase, making it difficult to achieve low viscosity. Further, inks in which polyethylene glycol is blended tend to become unable to eject due to drying in the nozzle of the recording head as the viscosity increases, i.e., make it difficult to ensure an intermittent ejection property. Further, inks in which polyethylene glycol is blended tend to adhere to a paper output roller of the inkjet recording apparatus, making it easier for a phenomenon (offset) in which subsequent recording media get dirty via the paper output roller to occur. In addition, the low-viscosity ink also has a problem of difficulty in ensuring redispersibility.

In view of the circumstances as described above, it is an object of the present disclosure to provide an ink capable of suppressing the occurrence of curling and offset while achieving low-viscosity, redispersibility, and an intermittent ejection property.

An embodiment of the present disclosure will be described.

### [Configuration of Ink]

### (Schematic Configuration)

An ink according to an embodiment of the present disclosure includes: a pigment a; a polyethylene glycol b; a water-soluble solid additive c; a penetrating agent d; a surfactant e; and water. The ink according to this embodiment is typically a water-based ink that is ejected from a recording head of an inkjet recording apparatus onto a recording medium to form an image on the recording medium. The recording medium on which an image is to be formed by the ink according to this embodiment includes a fiber such as a cellulose fiber. Examples of such a recording medium include plain paper, copy paper, recycled paper, thin paper, and thick paper.

In the ink according to this embodiment, the polyethylene glycol b includes a first polyethylene glycol b1 and a second polyethylene glycol b2. The first polyethylene glycol b1 is a polyethylene glycol having a number average molecular weight of 150 or more and less than 450. The second polyethylene glycol b2 is a polyethylene glycol having a number average molecular weight of 450 or more and less than 1050.

In the ink according to this embodiment, by keeping the total amount of the polyethylene glycol b relatively low, the viscosity at 25° C. can be set to 7.5 mPa·s or less. In this embodiment, the viscosity of the ink at 25° C. is measured using an E-type viscometer TV-100EL (manufactured by TOKISANGYO). Further, in the ink according to this embodiment, the action of the first polyethylene glycol b1 having a relatively small number average molecular weight allows redispersibility of the pigment a to be ensured. Therefore, in the ink according to this embodiment, it is possible to achieve both low viscosity and redispersibility.

In the ink according to this embodiment, in order to achieve high redispersibility, it is favorable that the content of the first polyethylene glycol b1 is high. However, it is not favorable that the content of the first polyethylene glycol b1 is too high, in order to keep the viscosity at 25° C. of 7.5 mPa·s or less. From these viewpoints, in the ink according to this embodiment, the content of the first polyethylene glycol b1 is 5 mass % or more and 10 mass % or less.

Further, in the ink according to this embodiment, the action of the second polyethylene glycol b2 having a relatively large number average molecular weight allows the hydrogen bonds between fibers forming the recording medium to be maintained when the ink permeates the recording medium. Further, in the ink according to this embodiment, it is conceivable that even if the hydrogen bonds between fibers forming the recording medium are broken, the recording medium is less likely to deform because the second polyethylene glycol b2 enters between the fibers where the hydrogen bonds are broken. For this reason, in the ink according to this embodiment, it is possible to suppress the occurrence of curling in the recording medium. In the ink according to this embodiment, in order to suppress the occurrence of curling more effectively, the second polyethylene glycol b2 favorably includes a polyethylene glycol having a number average molecular weight of 550 or more.

Further, in the ink according to this embodiment, the action of the second polyethylene glycol b2 having a relatively large number average molecular weight makes the ink less likely to adhere to the paper output roller of the inkjet recording apparatus. Therefore, in the ink according to this embodiment, it is possible to suppress the occurrence of offset.

In the ink according to this embodiment, in order to suppress the occurrence of curling and offset more effectively, it is favorable that the content of the second polyethylene glycol b2 is high. However, the higher the content of the second polyethylene glycol b2, the more difficult it becomes to ensure an intermittent ejection property. In this regard, in the ink according to this embodiment, the content of the second polyethylene glycol b2 is kept at a level sufficient to ensure an intermittent ejection property, and the water-soluble solid additive c having the effect of suppressing the occurrence of curling and offset similarly to the second polyethylene glycol b2 is blended to compensate for the deficiency of the second polyethylene glycol b2.

In the ink according to this embodiment, in order to suppress the occurrence of curling and offset more effectively, it is favorable that the content of the second polyethylene glycol b2 is high. However, it is not favorable that the content of the second polyethylene glycol b2 is too high, in order to keep the viscosity at 25° C. of 7.5 mPa·s or less and ensure an intermittent ejection property. From these viewpoints, in the ink according to this embodiment, the content of the second polyethylene glycol b2 is 1 mass % or more and 5 mass % or less. Further, in the ink according to this embodiment, in order to suppress the occurrence of curling and offset, the content of the water-soluble solid additive c is 3 mass % or more and 10 mass % or less.

As described above, in the ink according to this embodiment, the configurations of the polyethylene glycol b and the water-soluble solid additive c allow the occurrence of curling and offset to be suppressed while achieving low-viscosity, redispersibility, and an intermittent ejection property. In the ink according to this embodiment, in order to adjust the viscosity more accurately, it is favorable that polyethylene glycols b having different number average molecular weights are blended as the first polyethylene glycol b1 and polyethylene glycols b having different number average molecular weights are blended as the second polyethylene glycol b2.

Further, the action of the penetrating agent d makes it easier for the ink according to this embodiment to penetrate the recording medium. Further, the ink according to this embodiment becomes easier to penetrate the recording medium due to the reduction in surface tension caused by the action of the surfactant e. Therefore, the ink according to this embodiment dries quickly due to its rapid penetration into the recording medium, thereby suppressing the occurrence of offset more effectively. The ink according to this embodiment favorably has dynamic surface tension of 40.0 mN/m or less at a surface age of 10 ms. In this embodiment, the dynamic surface tension of the ink at the surface age of 10 ms is measured using a bubble pressure dynamic surface tensiometer (“BP-100” manufactured by KRUSS GmbH).

### (Pigment a)

In the ink according to this embodiment, for example, a yellow pigment, an orange pigment, a red pigment, a blue pigment, a purple pigment, or a black pigment can be used as the pigment a. Examples of the yellow pigment include C.I. Pigment Yellow 74, 93, 95, 109, 110, 120, 128, 138, 139, 151, 154, 155, 173, 180, 185, or 193. Examples of the orange pigment include C.I. Pigment Orange 34, 36, 43, 61, 63, or 71. Examples of the red pigment include C.I. Pigment Red 122 or 202. Examples of the blue pigment include C.I. Pigment Blue 15 or 15:3. Examples of the purple pigment include C.I. Pigment Violet 19, 23, or 33. Examples of the black pigment include C.I. Pigment Black 7.

The content of the pigment a in the ink according to this embodiment is favorably 4 mass % or more and 8 mass % or less. As a result, in the ink according to this embodiment, high image density in the image formed on the recording medium can be achieved more easily, and permeability into the recording medium can be ensured more easily. In the case where the content of the pigment a is less than 4 mass %, it becomes difficult to achieve high image density in the image formed on the recording medium. Meanwhile, in the case where the content of the pigment a exceeds 8 mass %, it becomes difficult to achieve permeability into the recording medium and fluidity of the pigment particle in the solvent cannot be ensured in some cases, thereby making it difficult to achieve high image density in the image formed on the recording medium.

As the pigment a, typically, a self-dispersing pigment is used. The self-dispersing pigment can be prepared by causing a pigment having no self-dispersibility to be subjected to physical surface treatment or chemical surface treatment by a known method. Examples of the physical surface treatment include vacuum plasma treatment. Examples of the chemical surface treatment include wet oxidation treatment involving oxidation with an oxidizing agent in water and treatment involving bonding p-aminobenzoic acid to the pigment surface (in this treatment, the carboxy group is bound to the pigment surface via a phenyl group).

As the self-dispersing pigment, commercial products can also be used. Examples of the commercial products of the self-dispersing pigment include CAB-O-Jet (registered trademark) series manufactured by Cabot Corporation (e.g., CAB-O-Jet (registered trademark) 200, 300, 400, 250C, 260M, 270Y, 450C, 465M, 470Y, and 480M) and BONJET (registered trademark) series manufactured by ORIENT CHEMICAL INDUSTRIES CO., LTD. (e.g., BONJET (registered trademark) CW-3 and CW-4).

Examples of the pigment that is a raw material of the self-dispersing pigment (pigment having no self-dispersibility) include a yellow pigment, an orange pigment, a red pigment, a blue pigment, a purple pigment, and a black pigment. Examples of the yellow pigment include C.I. Pigment Yellow (1, 2, 3, 12, 13, 14, 16, 17, 55, 73, 74, 75, 83, 93, 95, 97, 98, 109, 110, 114, 120, 128, 129, 138, 139, 150, 151, 154, 155, 173, 180, 185, and 193).

Examples of the orange pigment include C.I. Pigment Orange (34, 36, 43, 61, 63, and 71).

Examples of the red pigment include C.I. Pigment Red (5, 7, 12, 48, 48 (more specifically 48:1), 57, 112, 122, 123, 146, 168, 184, and 202).

Examples of the blue pigment include C.I. Pigment Blue (1, 2, 3, 15 (more specifically 15:3 and 15:4), 16, 22, and 60).

Examples of the purple pigment include C.I. Pigment Violet (19, 23, 33, and 1960).

Examples of the black pigment include No. 2300, No. 900, MCF88, No. 33, No. 40, No. 45, No. 52, MA7, MA8, MA100, No. 2200B, and the like manufactured by Mitsubishi Chemical Corporation, Raven (registered trademark) (5750, 5250, 5000, 3500, 1255, and 700) and the like manufactured by Columbia Chemical Corporation, conductive carbon black such as Regal (registered trademark) (400R, 330R, and 660R), Mogul (registered trademark) L, Monarch (registered trademark) (700, 800, 880, 900, 1000, 1100, 1300, and 1400), BLACK PEARLS (registered trademark) 2000, VULCAN (registered trademark) XC-72, VULCAN (registered trademark) P, and STERLIB (registered trademark) C manufactured by Cabot Corporation, and carbon black such as Color Black (FW1, FW2, FW2V, FW18, FW200, S150, S160, and S170), Printex (registered trademark) (35, U, V, and 140U), Special Black (4, 4A, 5, and 6), and the like manufactured by Orion Engineered Carbons S.A.

### (Polyethylene Glycol b)

Examples of the first polyethylene glycol b1 having a number average molecular weight of 150 or more and less than 450 include polyethylene glycol 200, polyethylene glycol 300, and polyethylene glycol 400. Examples of the second polyethylene glycol b2 having a number average molecular weight of 450 or more and less than 1050 include polyethylene glycol 500, polyethylene glycol 600, and polyethylene glycol 1000.

### (Water-Soluble Solid Additive c)

In the ink according to this embodiment, by blending the water-soluble solid additive c that is solid at 25° C., it is possible to suppress the occurrence of curling and offset and improve the rubfastness of the image formed on the recording medium. Examples of the water-soluble solid additive c blended in the ink according to this embodiment include a sugar alcohol (sorbitol, maltitol), a polyhydric alcohol (trimethylolpropane, neopentyl glycol, 1,6-hexanediol, trimethylethane, erythritol), a betaine, and ε-caprolactam.

### (Penetrating Agent d)

Examples of the penetrating agent d blended in the ink according to this embodiment include triethylene glycol monobutyl ether (BTG), 1,2-hexanediol, 1,2-octanediol, 2-methyl-2,4-pentanediol, dipropylene glycol monomethyl ether, and tripropylene glycol monomethyl ether. In the ink according to this embodiment, the content of the penetrating agent d is favorably 1 mass % or more and 10 mass % or less.

### (Surfactant e)

The surfactant e has the effect of enhancing the wettability of the ink on the recording medium and the effect of enhancing the compatibility and dispersion stability of the components included in the ink, in addition to the effect of enhancing the dryness of the ink. Examples of the surfactant e blended in the ink according to this embodiment include an anionic surfactant, a cationic surfactant, a non-ionic surfactant, and an amphoteric surfactant. As the surfactant blended in the ink according to this embodiment, a non-ionic surfactant is favorable, an acetylene surfactant is more favorable, and an acetylene glycol surfactant is still more favorable. The acetylene glycol surfactant has a low molecular weight and high symmetry, allowing the surface tension of the ink on the recording medium to be rapidly reduced.

The acetylene surfactant is an alcohol having an acetylene bond in its molecule. The alcohol having an acetylene bond in its molecule is favorably, for example, at least one of a glycol having an acetylene bond in its molecule and a monovalent alcohol having an acetylene bond in its molecule. As the acetylene glycol surfactant, commercial products can also be used. More specifically, the acetylene glycol surfactant is favorably “OLFINE (registered trademark) E1010” manufactured by Nissin Chemical Co., Ltd. For example, “OLFINE E1010” manufactured by Nissin Chemical Co., Ltd. includes an ethylene oxide adduct of acetylenediol, more specifically, polyoxyethylene acetylenic glycol ether.

In the ink according to this embodiment, from the viewpoints of suppressing offset and improving image density, the content of the surfactant e is favorably 0.05 mass % or more and 2.00 mass % or less.

### (Water)

In the ink according to this embodiment, ion exchanged water, purified water, distilled water, or the like can be used as water. In the ink according to this embodiment, from the viewpoints of dryness and ejection reliability, the content of water is favorably 40 mass % or more and 80 mass % or less, more favorably 55 mass % or more and 75 mass % or less, still more favorably 60 mass % or more and 70 mass % or less.

### (Other Components)

In the ink according to this embodiment, components other than the above may be blended as necessary. For example, in the ink according to this embodiment, a pigment dispersion resin for enhancing the dispersibility of the pigment a in the solvent may be blended. The pigment dispersion resin is fine particles of a resin and is adsorbed on the surface of the pigment a to suppress the agglomeration of the pigment a. In the ink in which a pigment dispersion resin is blended, the pigment a and the pigment dispersion resin integrally form a pigment particle (pigment dispersion). The pigment particle includes, for example, a core including the pigment a and a pigment dispersion resin that coats the core. In the pigment dispersion resin, part thereof may be dispersed and present in the solvent without being adsorbed on the surface of the pigment a. The pigment dispersion resin is favorably anionic.

As the pigment dispersion resin, a known pigment dispersion resin can be appropriately selected and used. Specific examples of the pigment dispersion resin include a styrene-acrylic resin, a styrene-maleic acid copolymer, a styrene-maleic acid half ester copolymer, a vinylnaphthalene-acrylic acid copolymer, and a vinyl naphthalene-maleic acid copolymer. The styrene-acrylic resin is a resin including a unit derived from styrene and a unit derived from acrylic acid, methacrylic acid, acrylic acid ester, or methacrylic acid ester. Examples of the styrene-acrylic resin include a styrene-acrylic acid-acrylic acid alkyl ester copolymer, a styrene-methacrylic acid-methacrylic acid alkyl ester-acrylic acid alkyl ester copolymer, a styrene-acrylic acid copolymer, a styrene-maleic acid-acrylic acid alkyl ester copolymer, a styrene-methacrylic acid copolymer, and a styrene-methacrylic acid alkyl ester copolymer. Of these pigment dispersion resins, a styrene-acrylic resin is favorable, a styrene-methacrylic acid-methacrylic acid alkyl ester-acrylic acid alkyl ester copolymer is more favorable, and a styrene-methacrylic acid-methyl methacrylate-butyl acrylate copolymer is particularly favorable because they are easily prepared and have an excellent effect of dispersing the pigment a.

In the ink according to this embodiment, in order to achieve the above effect, it is necessary to blend a certain amount of the pigment dispersion resin. Meanwhile, in the ink according to this embodiment, it is not favorable that the amount of the pigment dispersion resin is too high, in order to achieve high permeability. From these viewpoints, in the ink according to this embodiment, it is favorable to blend 15 parts by mass or more and 100 parts by mass or less of the pigment dispersion resin with respect to 100 parts by mass of the pigment a.

Further, in the ink according to this embodiment, various additives such as a dissolution stabilizer, an anti-drying agent, an antioxidant, a viscosity adjustor, a pH adjuster, a neutralizer, and an antifungal agent may be blended as necessary in addition to the above.

### EXAMPLES AND COMPARATIVE EXAMPLES

As Examples and Comparative Examples of the present disclosure, inks were prepared and evaluated. Note that the following Examples are merely illustrative examples of the present disclosure, and the present disclosure is not limited to the configurations of the following Examples.

### (Preparation of Ink)

First, a pigment dispersion liquid including the pigment a dispersed in water was prepared. The pigment dispersion resin was diluted with ion exchanged water, the pigment a was added thereto, and then, preliminary dispersion treatment was performed using a homodisper. After that, main dispersion treatment was performed using a bead mill (manufactured by NIPPON COKE & ENGINEERING. CO., LTD.) until the average particle size of the pigment particle reached 110 nm, thereby obtaining a pigment dispersion liquid. In all of Examples and Comparative Examples, “Black Pearls 800” manufactured by Cabot Corporation was used as the pigment a. Further, in all of Examples and Comparative Examples, “DISPERBYK-190” manufactured by BYK-Chemie GmbH was used as the pigment dispersion resin. Note that the water included in the pigment dispersion liquid constitutes the water component in each ink.

Next, inks according to Examples and Comparative Examples were prepared. The pigment dispersion liquid, the polyethylene glycol b, the water-soluble solid additive c, the penetrating agent d, the surfactant e, and ion exchanged water were weighed and added to a beaker, and the content of the beaker was stirred and mixed uniformly using a stirrer (“Three-One Motor BL-600” manufactured by Shinto Scientific Co., Ltd.) at a rotational speed of 400 rpm to obtain an ink. The ink was filtered using a filter (pore size of 5 μm) to remove foreign substances and coarse particles included in the ink.

### (Evaluation Method)

For the inks according to Examples and Comparative Examples, viscosity, redispersibility, an intermittent ejection property, and difficulty in the occurrence of offset and curling were evaluated.

### Method of Evaluating Viscosity

The viscosity of the ink was measured at 25° C. using an E-type viscometer TV-100EL (manufactured by TOKISANGYO). For the viscosity of each ink, evaluation was performed in accordance with the following criteria A to C. Inks with the evaluation of A or B for viscosity are evaluated to “Pass”, and inks with the evaluation of C are evaluated to “Fail”.
A: 6.5 mPa·s or less
B: exceeding 6.5 mPa·s and 7.5 mPa·s or less
C: exceeding 7.5 mPa·s.

### Method of Evaluating Redispersibility

A petri dish containing 2 g of each ink was set in a constant-temperature chamber and held at 40° C. for 72 hours. Ion exchanged water was added dropwise to each ink after holding at a rate of 5 ml/sec. The dispersion behavior of the pigment particle in each ink was visually observed until 10 seconds elapsed after adding dropwise. For the observation results, evaluation was performed in accordance with the following criteria A to C. Inks with the evaluation of A or B for redispersibility are evaluated to “Pass”, and Inks with the evaluation of C are evaluated to “Fail”.
A: The pigment particle dispersed quickly almost immediately after adding dropwise
B: The pigment particle dispersed in water over time after adding dropwise
C: The pigment particle did not disperse in water.

### Method of Evaluating Intermittent Ejection Property

The ink was ejected from all nozzles of the recording head in an environment of 32° C. and 10% RH, and 1-dot lines were formed on a recording medium in the main scanning direction using the recording head after a predetermined time elapsed. The elapsed time from the ejection of ink from all nozzles until the 1-dot line becomes impossible to form due to non-ejection was checked, and this elapsed time was used as an evaluation value for the intermittent ejection property. Using the evaluation value, evaluation was performed in the following criteria A to C. Inks with the evaluation of A or B for the intermittent ejection property are evaluated to “Pass”, and inks with the evaluation of C are evaluated to “Fail”.
A: 2 minutes or more
B: 1 minute or more and less than 2 minutes
C: less than 1 minute.

### Method of Evaluating Difficulty in Occurrence of Curling

A prototype evaluation device manufactured by KYOCERA Document Solutions Inc. was used as an inkjet recording apparatus, and “KJ4B-QA” manufactured by KYOCERA Document Solutions Inc. was used as a recording head. The ejection amount of ink per ejection in each nozzle of the recording head was set to 11 pL, and a 10 cm×10 cm solid image was formed on a recording medium (“C2” manufactured by FUJIFILM Business Innovation Corp. (A4 size)). Immediately after that, the recording medium on which the solid image was formed was placed on the upper surface of a horizontal stand such that the solid image of the recording medium and the upper surface of the horizontal stand face each other. Then, the heights of the recording medium at the four corners from the upper surface of the horizontal stand were measured, and the average value of the heights of the recording medium at the four corners was used as an evaluation value for the difficulty in the occurrence of curling. Using the evaluation value, evaluation was performed in accordance with the following criteria A to C as criteria for whether or not the recording medium can be adsorbed for forming an image on the second side (back side) in double-sided printing when a suction fan of 0.8 KPa is used to perform suction and adsorption via a conveyor belt and straighten the recording medium using a decurling mechanism. Inks with the evaluation of A or B for the difficulty in the occurrence of curling are evaluated to “Pass”, and inks with the evaluation of C are evaluated to “Fail”.
A: 10 mm or less
B: exceeding 10 mm and 20 mm or less
C: exceeding 20 mm.

### Method of Evaluating Difficulty in Occurrence of Offset

A prototype evaluation device manufactured by KYOCERA Document Solutions Inc. was used as an inkjet recording apparatus, and “KJ4B-QA” manufactured by KYOCERA Document Solutions Inc. was used as a recording head. First, the recording head located closest to the paper output roller in the evaluation device was filled with ink, and the excess liquid flowing onto the nozzle surface was wiped off using a wiping blade. In the evaluation device, the distance between the nozzle surface of the recording head and the recording medium was fixed to 1 mm, and the conveying speed of the recording medium from the paper feed roller to the paper output roller was set to 846.7 mm/sec. As the recording medium, “IJW” manufactured by Oji Paper Co., Ltd., which was cut to A4 size, was used. The amount of ink applied from the recording head to the recording medium was set to 15 g/m2, and a 10 cm×10 cm solid image was continuously formed on 10 recording media using the evaluation device. For the 10th recording medium, the region (offset region) that is likely to be stained by the ink adhered to the paper output roller was read using an image scanner (“GT-X820” manufactured by Seiko Epson Corp.) and binarized at a threshold value of 220. An offset area ratio (%) (=100×the number of black pixels/the total number of pixels) was calculated from the number of black pixels and the total number of pixels of the binarized image, and the calculated offset area ratio was used as an evaluation value for the difficulty in the occurrence of offset. Using the evaluation value, evaluation was performed in accordance with the following criteria A to D as criteria for whether or not stains on the recording paper caused by offset are visually observed. Inks with the evaluation of any of A to C for the difficulty in the occurrence of offset are evaluated to “Pass”, and inks with the evaluation of D are evaluated to “Fail”.
A: 0.020% or less
B: exceeding 0.020% and 0.025% or less
C: exceeding 0.025% and 0.030% or less
D: exceeding 0.030%

### Examples 1 to 21

In Examples 1 to 21, of PEG200, PEG400, PEG500, and PEG1000 manufactured by Tokyo Chemical Industry Co., Ltd., two types were used as the polyethylene glycol b. In all of Examples 1 to 21, trimethylolpropane (TMP) manufactured by Tokyo Chemical Industry Co., Ltd. was used as the water-soluble solid additive c, triethylene glycol monobutyl ether (BTG) manufactured by Tokyo Chemical Industry Co., Ltd. was used as the penetrating agent d, and “OLFINE E1010” manufactured by Nissin Chemical Co., Ltd., which is an acetylene glycol surfactant was used as the surfactant e. In all of the inks according to Examples 1 to 21, the content of the pigment a is 5 mass %, the content of the pigment dispersion resin is 2 mass %, the content of the surfactant e is 0.5 mass %, and the content of water is the remainder. Table 1 shows the type and content (mass %) of the polyethylene glycol b, the water-soluble solid additive c, and the penetrating agent d for the inks according to Examples 1 to 21.

TABLE 1

| | | | | | Water-soluble | Penetrating |
|---|---|---|---|---|---|---|
| | Polyethylene glycol b | | | | solid additive c | agent d |
| Example | 200 | 400 | 500 | 1000 | TMP | BTG |
| 1 | 10 | | 5 | | 3 | 1 |
| 2 | 10 | | | 5 | 3 | 1 |
| 3 | | 10 | 5 | | 3 | 1 |
| 4 | | 10 | | 5 | 3 | 1 |
| 5 | 5 | | 5 | | 3 | 1 |
| 6 | 5 | | | 5 | 3 | 1 |
| 7 | | 5 | 5 | | 3 | 1 |
| 8 | | 5 | | 5 | 3 | 1 |
| 9 | 10 | | 1 | | 3 | 1 |
| 10 | 10 | | | 1 | 3 | 1 |
| 11 | | 10 | 1 | | 3 | 1 |
| 12 | | 10 | | 1 | 3 | 1 |
| 13 | 5 | | 1 | | 3 | 1 |
| 14 | 5 | | | 1 | 3 | 1 |
| 15 | | 5 | 1 | | 3 | 1 |
| 16 | | 5 | | 1 | 3 | 1 |
| 17 | 10 | | 5 | | 10 | 1 |
| 18 | 10 | | | 5 | 10 | 1 |
| 19 | | 10 | 5 | | 10 | 1 |
| 20 | | 10 | | 5 | 10 | 1 |
| 21 | 10 | | 5 | | 3 | 10 |

For the inks according to Examples 1 to 21, viscosity, redispersibility, an intermittent ejection property, and difficulty in the occurrence of offset and curling were evaluated. Table 2 shows the evaluation results of viscosity, redispersibility, an intermittent ejection property, and difficulty in the occurrence of offset and curling for the inks according to Examples 1 to 21.

TABLE 2

| Ex- | Evaluation results | | | | |
|---|---|---|---|---|---|
| am- | Vis- | Redis- | Intermittent | | Off- |
| ple | cosity | persibility | ejection property | Curling | set |
| 1 | A | A | A | A | B |
| 2 | A | A | A | A | A |
| 3 | A | B | A | A | B |
| 4 | A | B | A | A | A |
| 5 | A | B | A | A | B |
| 6 | A | B | A | A | A |
| 7 | A | B | A | A | B |
| 8 | A | B | A | A | A |
| 9 | A | A | A | B | B |
| 10 | A | A | A | B | B |
| 11 | A | B | A | B | B |
| 12 | A | B | A | B | B |
| 13 | A | B | A | B | B |
| 14 | A | B | A | B | B |
| 15 | A | B | A | B | B |
| 16 | A | B | A | B | B |
| 17 | A | A | A | A | B |
| 18 | B | A | B | A | A |
| 19 | A | B | A | A | B |
| 20 | B | B | B | A | A |
| 21 | A | A | A | A | A |

In all of the inks according to Examples 1 to 21 in which the polyethylene glycol b and the water-soluble solid additive c have the configurations according to the above embodiment, the viscosity, redispersibility, intermittent ejection property, and difficulty in the occurrence of offset and curling were evaluated to “Pass”. Further, when comparing Example 1 and Example 21, it can be seen that offset is less likely to occur in the ink according to Example 21 in which the content of the penetrating agent d is high. This is presumably because in the ink according to Example 21, the penetration into the recording medium was promoted more, resulting in rapid drying.

### Comparative Examples 1 to 7

In Comparative Examples 1 to 7, of PEG100, PEG200, PEG400, PEG600, PEG1000, and PEG2000 manufactured by Tokyo Chemical Industry Co., Ltd., two types were used as the polyethylene glycol b. Further, in all of Comparative Examples 1 to 7, trimethylolpropane (TMP) manufactured by Tokyo Chemical Industry Co., Ltd. was used as the water-soluble solid additive c, triethylene glycol monobutyl ether (BTG) manufactured by Tokyo Chemical Industry Co., Ltd. was used as the penetrating agent d, and “OLFINE E1010” manufactured by Nissin Chemical Co., Ltd. was used as the surfactant e. In all of the inks according to Comparative Examples 1 to 7, the content of the pigment a is 5 mass %, the content of the pigment dispersion resin is 2 mass %, the content of the penetrating agent d is 1 mass %, the content of the surfactant e is 0.5 mass %, and the content of water is the remainder. Table 3 shows the type and content (mass %) of the polyethylene glycol b and a water-soluble solid additive c for the inks according to Comparative Examples 1 to 7.

TABLE 3

| | | | | | | | Water-soluble |
|---|---|---|---|---|---|---|---|
| Comparative | Polyethylene glycol b | | | | | | solid additive c |
| Example | 100 | 200 | 400 | 600 | 1000 | 2000 | TMP |
| 1 | | 10 | | | 10 | | 0 |
| 2 | | | 10 | | 10 | | 0 |
| 3 | | 5 | | | 10 | | 0 |
| 4 | | | 5 | | 10 | | 0 |
| 5 | 10 | | | | | 10 | 3 |
| 6 | | 10 | | | | 10 | 3 |
| 7 | 10 | | | 10 | | | 3 |

The inks according to Comparative Examples 1 and 2 are different from the ink according to the above Example in that the first polyethylene glycol b1 and the second polyethylene glycol b2 are excessive and the water-soluble solid additive c is not blended. The inks according to Comparative Examples 3 and 4 are different from the ink according to the above Example in that the second polyethylene glycol b2 is excessive and the water-soluble solid additive c is not blended. The ink according to Comparative Example 5 is different from the ink according to the above Example in that the polyethylene glycol b having a number average molecular weight smaller than that of the first polyethylene glycol b1 and the polyethylene glycol b having a number average molecular weight larger than that of the second polyethylene glycol b2 are blended. The ink according to Comparative Example 6 is different from the ink according to the above Example in that the first polyethylene glycol b1 is excessive and the polyethylene glycol b having a number average molecular weight larger than that of the second polyethylene glycol b2 is blended. The ink according to Comparative Example 7 is different from the ink according to the above Example in that the polyethylene glycol b having a number average molecular weight smaller than that of the first polyethylene glycol b1 is blended and the second polyethylene glycol b2 is excessive.

For the inks according to Comparative Examples 1 to 7, viscosity, redispersibility, an intermittent ejection property, and difficulty in the occurrence of offset and curling were evaluated. Table 4 shows the evaluation results of viscosity, redispersibility, an intermittent ejection property, and difficulty in the occurrence of offset and curling for the inks according to Comparative Examples 1 to 7.

TABLE 4

| Com- | Evaluation results | | | | |
|---|---|---|---|---|---|
| parative | Vis- | Redis- | Intermittent | | Off- |
| Example | cosity | persibility | ejection property | Curling | set |
| 1 | A | A | C | A | A |
| 2 | B | B | C | A | A |
| 3 | A | B | C | A | A |
| 4 | A | B | C | A | A |
| 5 | A | C | C | A | A |
| 6 | A | A | C | A | A |
| 7 | A | C | C | A | A |

In all of Comparative Examples 1 to 7 in which a large amount of the polyethylene glycol b having a large number average molecular weight is blended, the intermittent ejection property was evaluated to “Fail”. Further, in Comparative Examples 5 and 7 in which the first polyethylene glycol b1 is not blended, the redispersibility was also evaluated to “Fail”.

It should be understood by those skilled in the art that various modifications, combinations, sub-combinations and alterations may occur depending on design requirements and other factors insofar as they are within the scope of the appended claims or the equivalents thereof.

What is claimed is:

1. An ink having viscosity of 7.5 mPa·s or less at 25° C., comprising:
a pigment a;
a polyethylene glycol b;
a water-soluble solid additive c that is solid at 25° C.;
a penetrating agent d;
a surfactant e; and
water,
the polyethylene glycol b including a first polyethylene glycol b1 having a number average molecular weight of 150 or more and less than 450 and a second polyethylene glycol b2 having a number average molecular weight of 450 or more and less than 1050,
a content of the first polyethylene glycol b1 being 5 mass % or more and 10 mass % or less,
a content of the second polyethylene glycol b2 being 1 mass % or more and 5 mass % or less,
a content of the water-soluble solid additive c being 3 mass % or more and 10 mass % or less.

2. The ink according to claim 1, wherein
the first polyethylene glycol b1 includes polyethylene glycols having different number average molecular weights.

3. The ink according to claim 1, wherein
the second polyethylene glycol b2 includes polyethylene glycols having different number average molecular weights.

4. The ink according to claim 1, wherein
the second polyethylene glycol b2 includes a polyethylene glycol having a number average molecular weight of 550 or more.

5. The ink according to claim 1, wherein the ink has
dynamic surface tension of 40.0 mN/m or less at a surface age of 10 ms.
